(19) United States
(12) Patent Application Publication
(10) Pub. No.: US 2025/0062555 A1
(43) Pub. Date: Feb. 20, 2025

(54) Electrical Connection Terminal and Electrical Connection Assembly

(71) Applicants: Tyco Electronics (Suzhou) Ltd., Suzhou City (CN); Tyco Electronics Technology (SIP) Co., Ltd., Suzhou (CN); Tyco Electronics (Shanghai) Co., Ltd., Shanghai (CN)

(72) Inventors: Kai Wang, Suzhou (CN); Weidong Zhang, Shanghai (CN); Jingjing (Justin) Gu, Suzhou (CN)

(73) Assignees: Tyco Electronics (Suzhou) Ltd., Suzhou (CN); Tyco Electronics Technology (SIP) Co., Ltd., Suzhou (CN); Tyco Electronics (Shanghai) Co., Ltd., Shanghai (CN)

(21) Appl. No.: 18/801,969

(22) Filed: Aug. 13, 2024

(30) Foreign Application Priority Data
Aug. 16, 2023 (CN) 202311033869.1

(51) Int. Cl. H01R 12/70; H01R 4/18; H01R 4/2407; H01R 12/81

(52) U.S. Cl. CPC H01R 12/7035; H01R 4/182; H01R 4/2407; H01R 12/81

(57) ABSTRACT

An electrical connection terminal includes a crimping part having a base with a front end and a rear end and a pair of opposite sides, a plurality of conductive teeth connected to the opposite sides of the base, and a plurality of fixing teeth connected to the opposite sides at the front end of the base. The electrical connection terminal has a main body connected to the rear end of the base. The conductive teeth pierce an insulator of a flexible electrical connection piece and are crimpable onto a conductor of the flexible electrical connection piece to be electrically connected to the flexible electrical connection piece. The fixing teeth pierce the insulator of the flexible electrical connection piece and are crimpable onto the insulator of the flexible electrical connection piece to fix the front end of the base to the flexible electrical connection piece.

### CROSS-REFERENCE TO RELATED APPLICATIONS

This application claims the benefit of the filing date under 35 U.S.C. § 119 (a)-(d) of Chinese Patent Application No. 202311033869.1, filed on Aug. 16, 2023.

### FIELD OF THE INVENTION

The present invention relates to an electrical connection terminal and an electrical connection assembly comprising the electrical connection terminal.

### BACKGROUND OF THE INVENTION

An electrical connection terminal that is electrically connected to a Flexible Printed Circuit (FPC) or a Flexible Flat Cable (FFC) typically includes a main body and a crimping part. Multiple electrical contact teeth are formed on both sides of the crimping part of the electrical connection terminal, which pierce through the insulation layer of the FPC or FFC and is crimped onto the conductor of the FPC or FFC to electrically connect with the conductor of the FPC or FFC.

The rear end of the crimping part of the electrical connection terminal is connected to the main body, and the front end of the crimping part of the electrical connection terminal is not fixed to the FPC or FFC. Thus, the front end of the crimping part of the electrical connection terminal can be moved up and down relative to the FPC or FFC, which makes the FPC or FFC easily cut off by the sharp edge of the front end of the crimping part. Once the FPC or FFC is cut off, the entire electrical connection assembly needs to be replaced.

### SUMMARY OF THE INVENTION

An electrical connection terminal includes a crimping part having a base with a front end and a rear end and a pair of opposite sides, a plurality of conductive teeth connected to the opposite sides of the base, and a plurality of fixing teeth connected to the opposite sides at the front end of the base. The electrical connection terminal has a main body connected to the rear end of the base. The conductive teeth pierce an insulator of a flexible electrical connection piece and are crimpable onto a conductor of the flexible electrical connection piece to be electrically connected to the flexible electrical connection piece. The fixing teeth pierce the insulator of the flexible electrical connection piece and are crimpable onto the insulator of the flexible electrical connection piece to fix the front end of the base to the flexible electrical connection piece.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of an electrical connection terminal according to an exemplary embodiment of the present invention, wherein the electrical connection terminal has not yet been crimped onto the flexible electrical connection piece;

FIG. 2 shows a side view of an electrical connection terminal according to an exemplary embodiment of the present invention, wherein the electrical connection terminal has not yet been crimped onto the flexible electrical connection piece;

FIG. 3 shows an illustrative perspective view of an electrical connection assembly according to an exemplary embodiment of the present invention;

FIG. 4 shows an illustrative exploded view of an electrical connection assembly according to an exemplary embodiment of the present invention;

FIG. 5 shows an illustrative perspective view of an electrical connection terminal according to an exemplary embodiment of the present invention when viewed from the rear, wherein the electrical connection terminal is in a crimped state;

FIG. 6 shows an illustrative perspective view of an electrical connection terminal according to an exemplary embodiment of the present invention when viewed from the front side, wherein the electrical connection terminal is in a crimped state;

FIG. 7 shows an illustrative plan view of an electrical connection terminal according to an exemplary embodiment of the present invention when viewed from the top, wherein the electrical connection terminal is in a crimped state;

FIG. 8 shows a cross-sectional view of an electrical connection assembly at one position according to an exemplary embodiment of the present invention; and

FIG. 9 shows a cross-sectional view of the electrical connection assembly at another position according to an exemplary embodiment of the present invention.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

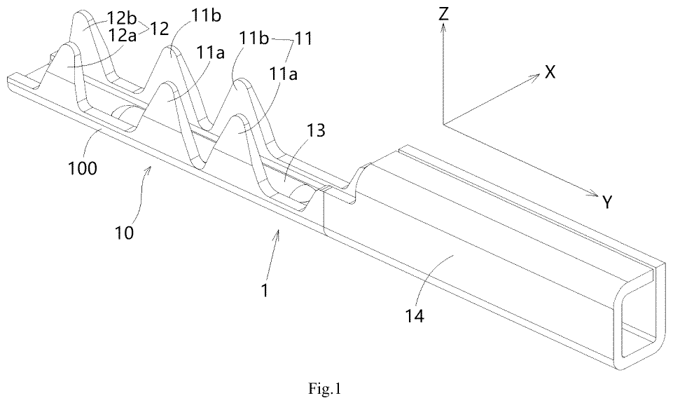

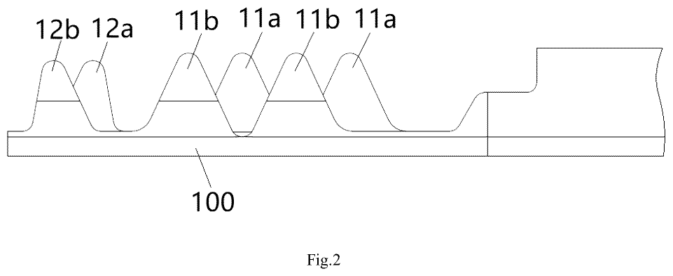

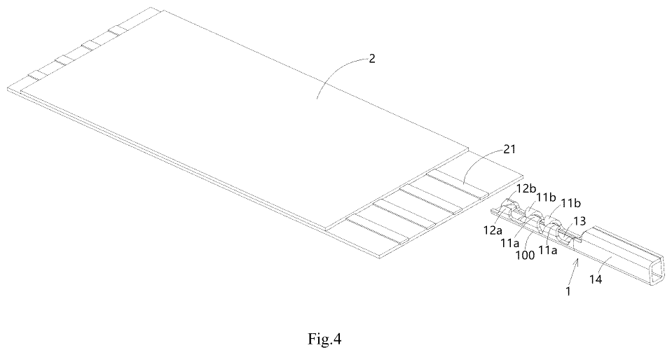

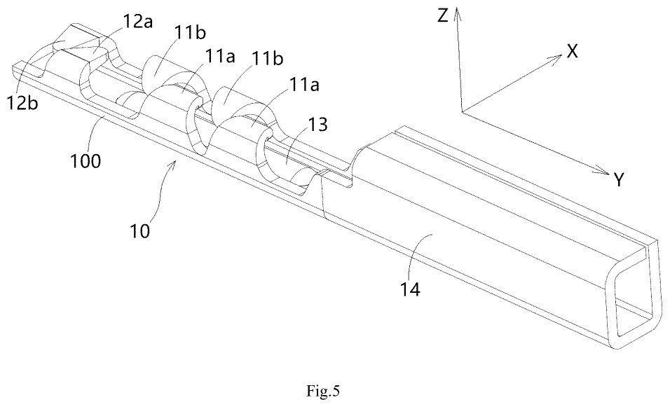

As shown in FIGS. 1 to 6, in an exemplary embodiment of the present invention, an electrical connection terminal 1 is disclosed. The electrical connection terminal 1 includes a crimping part 10 and a main body 14. The crimping part 10 includes a base 100, a plurality of conductive teeth 11, and a plurality of fixing teeth 12. The base 100 has a front end and a rear end opposite to each other in its longitudinal direction Y, as well as two opposite sides in its transverse direction X. The plurality of conductive teeth 11 are connected to both sides of the base 100 and are located between the front and rear ends of the base 100. The plurality of fixing teeth 12 are connected to both sides of the front end of the base 100. The rear end of the base 100 is connected to the main body 14.

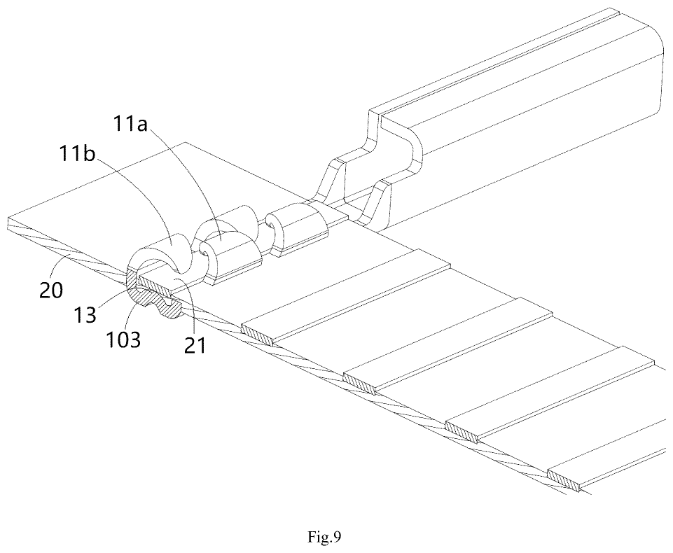

In the illustrated embodiments, the conductive teeth 11 of the crimping part 10 are suitable for piercing an insulator 20 of a flexible electrical connection piece 2 and being crimped onto a conductor 21 of the flexible electrical connection piece 2 to be electrically connected to the flexible electrical connection piece 2, as shown in FIGS. 8 and 9. The fixing teeth 12 of the crimping part 10 are suitable for piercing the insulator 20 of the flexible electrical connection piece 2 and being crimped onto the insulator 20 of the flexible electrical connection piece 2 to fix the front end of the base 100 to the flexible electrical connection piece 2.

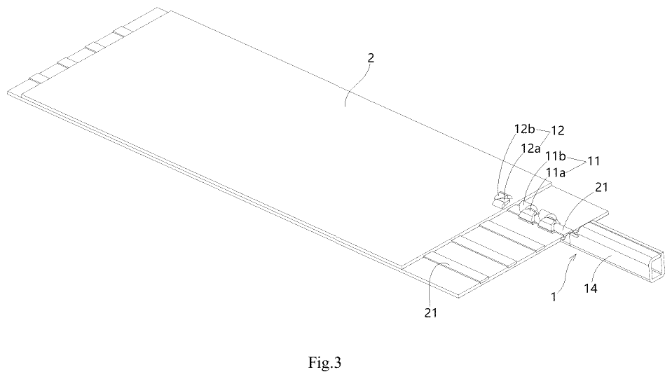

In the illustrated embodiments, as shown in FIG. 3, the front end of the crimping part 10 of the electrical connection terminal 1 is fixed to the flexible electrical connection piece 2, so that the front end of the crimping part 10 of the electrical connection terminal 1 can be moved synchronously with the flexible electrical connection piece 2 and will not be moved up and down relative to the flexible electrical connection piece 2, thereby avoiding the sharp edge of the front end of the crimping part 10 from cutting the flexible electrical connection piece 2.

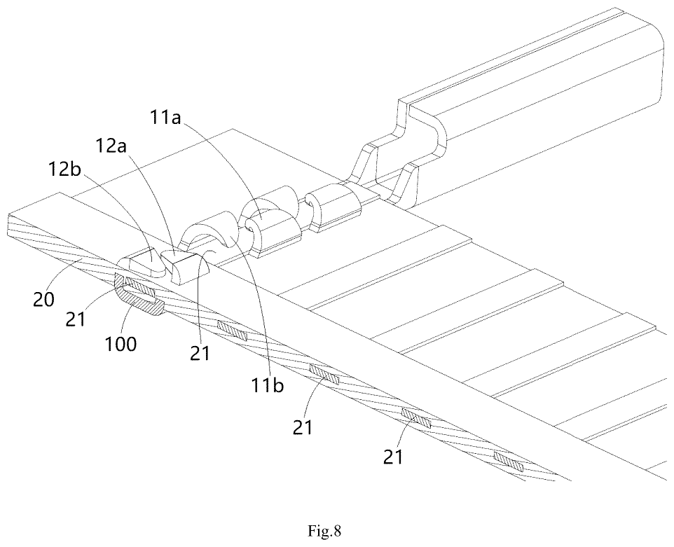

As shown in FIGS. 1 to 8, in the illustrated embodiments, the fixing teeth 12 include a first fixing tooth 12a and a second fixing tooth 12b. The first fixing tooth 12a is connected to one side of the front end of the base 100 (left side in FIG. 1). The second fixing tooth 12b is connected to the other side of the front end of the base 100 (the right side in FIG. 1). The first fixing tooth 12a and its adjacent second fixing tooth 12b are staggered in the longitudinal direction Y of the base 100. That is, the first fixing tooth 12a is not aligned with the adjacent second fixing tooth 12b in the transverse direction X of the base 100.

As shown in FIGS. 1 to 9, in the illustrated embodiments, the conductive teeth 11 include a first conductive tooth 11a and a second conductive tooth 11b. The first conductive tooth 11a is connected to one side of the base 100. The second conductive tooth 11b is connected to the other side of the base 100. The first conductive tooth 11a and its adjacent second conductive tooth 11b are staggered in the longitudinal direction Y of the base 100. That is, the first conductive tooth 11a is not aligned with the adjacent second conductive tooth 11b in the transverse direction X of the base 100.

In the illustrated embodiments, the conductive teeth 11 include multiple first conductive teeth 11a. Multiple first conductive teeth 11a are connected to one side of the base 100 and spaced in the longitudinal direction Y of the base 100. In the illustrated embodiments, the conductive teeth 11 include multiple second conductive teeth 11b. Multiple second conductive teeth 11b are connected to the other side of the base 100 and spaced in the longitudinal direction Y of the base 100.

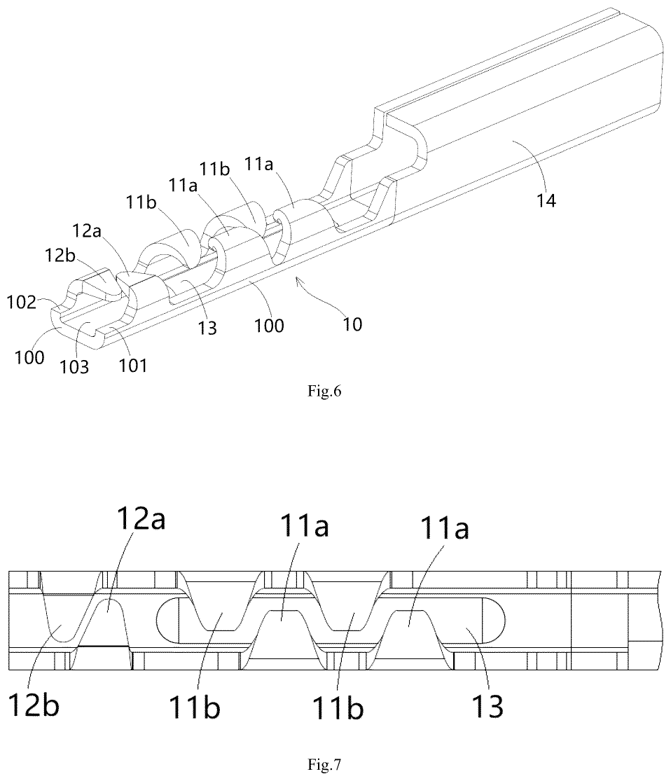

In the illustrated embodiment, the cross-section of the base 100 of the crimping part 10 is U-shaped. The base 100 of the crimping part 10, as shown in FIG. 6, includes a bottom plate 103 and two sidewalls 101 and 102. The bottom plate 103 of the base 100 extends along the longitudinal direction Y and the transverse direction X. The two sidewalls 101 and 102 of the base 100 are respectively connected to the transverse sides of the bottom plate 103. The sidewalls 101 and 102 extend along the longitudinal direction Y and a thickness direction Z of the bottom plate 103.

As shown in FIG. 6, the first fixing tooth 12a and the first conductive tooth 11a are connected to the upper side of one of the sidewalls 101 and 102. The second fixing tooth 12b and the second conductive tooth 11b are connected to the upper side of the other of the two sidewalls 101 and 102.

As shown in FIGS. 1 and 5 to 7, in the illustrated embodiments, a rib 13 is formed on the inner side of the bottom plate 103 of the base 100, which extends a predetermined length along the longitudinal direction Y. The rib 13 and the conductive teeth 11 of the crimping part 10 are used to respectively rest against the opposite sides of conductor 21 of the flexible electrical connection piece 2, to ensure reliable electrical contact between the conductive teeth 11 and the conductor 21. That is, as shown in FIG. 8, the rib 13 is used to rest against the bottom side of the conductor 21 of the flexible electrical connection piece 2, the ends of the conductive teeth 11 are used to rest against the top side of the conductor 21 of the flexible electrical connection piece 2, so that the conductor 21 of the flexible electrical connection piece 2 is clamped between the rib 13 and the ends of the conductive teeth 11 of the crimping part 10.

In the illustrated embodiments, the main body 14 of the electrical connection terminal 1 is suitable for mating with a mating terminal. However, the present invention is not limited to the illustrated embodiments, for example, the main body 14 of the electrical connection terminal 1 can also be formed to be suitable for being welded or crimped onto a conductive terminal or suitable for being welded or crimped onto a wire.

In an embodiment, the electrical connection terminal 1 is an integral stamped piece. In this way, manufacturing costs can be reduced.

As shown in FIGS. 3, 4, 8, and 9, in another exemplary embodiment of the present invention, an electrical connection assembly is also disclosed. The electrical connection assembly includes a flexible electrical connection piece 2 and the electrical connection terminal 1 as described in the embodiments above. The flexible electrical connection piece 2 includes an insulator 20 and a conductor 21 provided in the insulator 20. The crimping part 10 of the electrical connection terminal 1 is crimped onto the flexible electrical connection piece 2. In the illustrated embodiments, the flexible electrical connection piece 2 can be a Flexible Printed Circuit (FPC) or a Flexible Flat Cable (FFC).

As shown in FIGS. 3, 4, 8, and 9, in the illustrated embodiments, the conductive teeth 11 of the crimping part 10 of the electrical connection terminal 1 puncture the insulator 20 of the flexible electrical connection piece 2 and are crimped onto the conductor 21 to be electrically connected to the flexible electrical connection piece 2. The fixing teeth 12 of the crimping part 10 of the electrical connection terminal 1 pierce the insulator 20 of the flexible electrical connection piece 2 and are crimped onto the insulator 20 of the flexible electrical connection piece 2 to fix the front end of the electrical connection terminal 1 to the flexible electrical connection piece 2.

As shown in FIG. 8, the insulator 20 of the flexible electrical connection piece 2 is flat and has two surfaces opposite to each other in its thickness direction Z. The base 100 of the crimping part 10 and the fixing teeth 12 are respectively pressed against the opposite surfaces of the insulator 20 of the flexible electrical connection piece 2, so that the front end of the crimping part 10 is fixed to the insulator 20 of the flexible electrical connection piece 2. That is, the base 100 is pressed against the bottom surface of the insulator 20 of the flexible electrical connection piece 2, the ends of the fixing teeth 12 are pressed against the top surface of the insulator 20 of the flexible electrical connection piece 2, so that the insulator 20 of the flexible electrical connection piece 2 is clamped between the base 100 and the ends of the fixing teeth 12 of the crimping part 10.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. An electrical connection terminal, comprising:
a crimping part including a base having a front end and a rear end opposite to the front end in a longitudinal direction and a pair of opposite sides in a transverse direction, a plurality of conductive teeth connected to the opposite sides of the base and located between the front end and the rear end of the base, and a plurality of fixing teeth connected to the opposite sides at the front end of the base; and
a main body connected to the rear end of the base, the conductive teeth pierce an insulator of a flexible electrical connection piece and are crimpable onto a conductor of the flexible electrical connection piece to be electrically connected to the flexible electrical connection piece, the fixing teeth pierce the insulator of the flexible electrical connection piece and are crimpable onto the insulator of the flexible electrical connection piece to fix the front end of the base to the flexible electrical connection piece.

2. The electrical connection terminal of claim 1, wherein the plurality of fixing teeth include a first fixing tooth connected to one of the opposite sides at the front end of the base and a second fixing tooth connected to the other of the opposite sides at the front end of the base.

3. The electrical connection terminal of claim 2, wherein the first fixing tooth and the second fixing tooth are staggered in the longitudinal direction.

4. The electrical connection terminal of claim 3, wherein the plurality of conductive teeth include a first conductive tooth connected to one of the opposite sides of the base and a second conductive tooth connected to the other of the opposite sides of the base.

5. The electrical connection terminal of claim 4, wherein the first conductive tooth and the second conductive tooth are staggered in the longitudinal direction.

6. The electrical connection terminal of claim 4, wherein the first conductive tooth is one of a plurality of first conductive teeth spaced from one another in the longitudinal direction.

7. The electrical connection terminal of claim 4, wherein the second conductive tooth is one of a plurality of second conductive teeth spaced from one another in the longitudinal direction.

8. The electrical connection terminal of claim 4, wherein the base has a U-shaped cross-section including a bottom plate extending along the longitudinal direction and the transverse direction and a pair of sidewalls connected to the bottom plate and opposite each other in the transverse direction.

9. The electrical connection terminal of claim 8, wherein the sidewalls extend along the longitudinal direction and a thickness direction of the bottom plate.

10. The electrical connection terminal of claim 9, wherein the first fixing tooth and the first conductive tooth are connected to an upper side of one of the sidewalls.

11. The electrical connection terminal of claim 10, wherein the second fixing tooth and the second conductive tooth are connected to an upper side of the other of the sidewalls.

12. The electrical connection terminal of claim 8, wherein the bottom plate has a rib extending a predetermined length along the longitudinal direction.

13. The electrical connection terminal of claim 12, wherein the rib and the conductive teeth abut against opposite sides of the conductor of the flexible electrical connection piece.

14. The electrical connection terminal of claim 1, wherein the main body is at least one of: matable with a mating terminal, weldable or crimpable to a conductive terminal, or weldable or crimpable to a wire.

15. The electrical connection terminal of claim 1, wherein the electrical connection terminal is an integral stamped piece.

16. An electrical connection assembly, comprising:
a flexible electrical connection piece including an insulator and a conductor provided within the insulator; and
an electrical connection terminal crimped to the flexible electrical connection piece, the electrical connection terminal including:
a crimping part including a base having a front end and a rear end opposite to the front end in a longitudinal direction and a pair of opposite sides in a transverse direction, a plurality of conductive teeth connected to the opposite sides of the base and located between the front end and the rear end of the base, and a plurality of fixing teeth connected to the opposite sides at the front end of the base, the conductive teeth pierce the insulator of the flexible electrical connection piece and are crimped onto the conductor of the flexible electrical connection piece to be electrically connected to the flexible electrical connection piece, the fixing teeth pierce the insulator of the flexible electrical connection piece and are crimped onto the insulator of the flexible electrical connection piece to fix the front end of the base to the flexible electrical connection piece; and
a main body connected to the rear end of the base.

17. The electrical connection assembly of claim 16, wherein the insulator of the flexible electrical connection piece is flat and has a pair of surfaces opposite to each other in a thickness direction.

18. The electrical connection assembly of claim 17, wherein the base and the fixing teeth of the crimping part are respectively pressed against the surfaces of the insulator of the flexible electrical connection piece.

19. The electrical connection assembly of claim 16, wherein the flexible electrical connection piece is a Flexible Printed Circuit or a Flexible Flat Cable.
